(19) United States
(12) Patent Application Publication
(10) Pub. No.: US 2025/0162761 A1
(43) Pub. Date: May 22, 2025

(54) COUPLER AND PACKAGING BOX

(71) Applicant: Shinya Suehiro, Kanagawa (JP)

(72) Inventor: Shinya Suehiro, Kanagawa (JP)

(73) Assignee: Ricoh Company, Ltd., Tokyo (JP)

(21) Appl. No.: 18/931,949

(22) Filed: Oct. 30, 2024

(30) Foreign Application Priority Data
Nov. 20, 2023 (JP) 2023-196407

(51) Int. Cl. B65D 19/38

(52) U.S. Cl. CPC B65D 19/38; B65D 2519/00661

(57) ABSTRACT

A coupler includes an insertion portion, a flange, a hook, an elastic support, and a removal force receiver. The insertion portion is to be inserted through first and second openings of overlapped first and second coupling objects, respectively. The flange contacts the second opening of the second coupling object at the most upstream in an insertion position when the insertion portion is inserted to the first and second openings. The hook sandwiches the first and second coupling objects between the hook and the flange. The elastic support supports the hook displaceable in a direction orthogonal to the insertion direction. The removal force receiver receives a removal force in a removal direction, elastically deforms the elastic support by the removal force, and displaces the hook inward of the first and second openings, to remove the insertion portion from the first and second openings.

### CROSS-REFERENCE TO RELATED APPLICATION

This patent application is based on and claims priority pursuant to 35 U.S.C. § 119 (a) to Japanese Patent Application No. 2023-196407, filed on Nov. 20, 2023, in the Japan Patent Office, the entire disclosure of which is hereby incorporated by reference herein.

### BACKGROUND

### Technical Field

Embodiments of the present disclosure relate to a coupler and a packaging box.

### Background Art

Various typical couplers include multiple insertion portions, a flange, and a gripping portion (for example, a hook). The multiple insertion portions are inserted into corresponding through holes in corresponding coupling objects with the multiple coupling objects overlapping each other. The flange is disposed upstream from the insertion portions in an insertion direction and contacts the edge of the through hole of the extreme upstream coupling object in the insertion direction when the insertion portions are inserted into the corresponding through holes. The gripping portion brings the multiple coupling objects to be gripped between the gripping portion and the flange when the multiple insertion portions are inserted into the corresponding through holes.

For example, a packaging box in the art discloses a configuration in which a tray-equipped pallet and an upper box placed on the tray-equipped pallet are coupled to each other by a packaging fastener (coupler). In this packaging box, the through hole in the upper side wall of the tray-equipped pallet and the through hole in the lower portion of the upper box are arranged so as to overlap each other, and the packaging fastener is inserted into both the through holes. By so doing, the tray-equipped pallet and the upper box are coupled to each other. The packaging fastener includes a base and a key member. The base includes a first tubular portion (insertion portion), a jaw (flange portion), and a hook (gripping portion). The key member is coupled to a side of the base by a coupling piece and includes a second tubular portion and a lock claw.

When coupling, first, the first tubular portion of the base is inserted into both through holes, then the key member is turned to be folded back to the base by bending the connecting piece, and the second tubular portion of the key member is inserted into the first tubular portion of the base. Accordingly, the hook portion disposed inside the first tubular portion of the base is pushed out by the second tubular portion of the key member and protrudes to be substantially parallel to the jaw of the base, and the lock claw of the key member engages with an engagement target portion on the inner wall of the first tubular portion of the base. As a result, the side wall of the tray-equipped pallet and the upper box are sandwiched between the jaw (flange portion) and the hook member, with the key member locked to the base, and the tray-equipped pallet and the upper box are coupled to each other.

On the other hand, when the key member is detached, the key member is elastically deformed by pinching a given portion of the key member with fingers of the operator, and the lock claw of the key member is detached from the engagement target portion of the base. Then, the hook member is retracted into the inside of the first tubular portion of the base by pulling out the second tubular portion of the key member from the first tubular portion of the base while the key member is held by the fingers. Finally, the first tubular portion of the base is pulled out from the through hole. By so doing, the packaging fastener is removed and the connection between the tray-equipped pallet and the upper box is released.

In typical couplers, the operations are complicated when the coupler is attached to or removed from the coupler.

### SUMMARY

Embodiments of the present disclosure described herein provide a novel coupler including an insertion portion, a flange, a hook, an elastic support, and a removal force receiver. The insertion portion is to be inserted, through each of a first opening of a first coupling object and a second opening of a second coupling object overlapped with and upstream of the first coupling object, in an insertion direction. The flange is coupled to an upstream portion of the insertion portion in the insertion direction. The flange contacts an edge, adjacent to the second opening, of the second coupling object at the most upstream in the insertion position when the insertion portion is inserted to the first opening and the second opening. The hook sandwiches the first coupling object and the second coupling object between the hook and the flange when the insertion portion is inserted into the first opening and the second opening. The elastic support supports the hook displaceable in a direction orthogonal to the insertion direction. The removal force receiver is coupled to the elastic support to receive a removal force in a removal direction opposite to the insertion direction, elastically deform the elastic support by the removal force, and displace the hook inward of the first opening and the second opening, to remove the insertion portion from the first opening and the second opening.

Further, embodiments of the present disclosure described herein provide a packaging box including multiple coupling objects coupled by the above-described coupler.

Further, embodiments of the present disclosure described herein provide a coupler including a flange, an insertion portion, multiple hooks, an elastic support, and a removal force receiver. The flange has an opening. The insertion portion protrudes from the flange. The multiple hooks each of which is disposed an end of the insertion portion in an insertion direction of the insertion portion. The elastic support supports the multiple hooks to be displaceable. The removal force receiver is coupled to the elastic support inside the insertion portion. The removal force receiver is exposed from the opening of the flange.

Further, embodiments of the present disclosure described herein provide a packaging box including multiple coupling objects coupled by the above-described coupler.

### BRIEF DESCRIPTION OF THE SEVERAL VIEWS OF THE DRAWINGS

Exemplary embodiments of this disclosure will be described in detail based on the following figures, wherein:

FIG. 1A is a perspective view of a packaging box according to an embodiment of the present disclosure; FIG. 1B is a perspective view of the packaging box of FIG. 1A, including products drawn in broken lines;

FIG. 2 is a front perspective view of a coupler used for the packaging box;

FIG. 3 is a perspective view of the coupler viewed from the back side;

FIG. 4 is a cross-sectional view of the coupler when a side wall of an outer box included in the packaging box and a side wall of a pallet are coupled to each other by the coupler;

FIG. 5 is a diagram illustrating how a coupler moves when the coupler is removed from the side wall of an outer box and the side wall of a pallet;

FIG. 6 is a diagram illustrating how a coupler moves when the side wall of an outer box and the side wall of a pallet are coupled to each other with the coupler;

FIG. 7 is a cross-sectional view of a coupler including a removal piece that is a linear member;

FIG. 8 is a cross-sectional view of a coupler including a removal piece that is a curved member protruding outward in a removal direction;

FIG. 9 is a cross-sectional view of a coupler including a removal piece that is coupled to an elastic support at a coupling position disposed downstream from the elastic support in an insertion direction;

FIG. 10 is a front perspective view of a coupler having a separation structure in which an elastic support is displaceably separated from another portion of a base of the coupler;

FIG. 11 is a rear perspective view of a coupler having a removal piece disposed at a position displaced from the center position in the lateral direction of an inner space of a base;

FIG. 12 is a front view of the coupler of FIG. 11;

FIG. 13 is a partial cross-sectional perspective view of a coupler having no base rear side wall on the rear side of a base;

FIG. 14 is a front perspective view of a coupler having a pull piece on a removal piece;

FIG. 15 is a rear view of a coupler covered by a base rear side wall over the entire lateral area on the rear side of a base;

FIG. 16 is a rear perspective view of the coupler of FIG. 15;

FIG. 17 is a cross-sectional view of the coupler of FIG. 15; and

FIG. 18 is a front view of a typical packaging fastener detached from a through hole.

The accompanying drawings are intended to depict embodiments of the present disclosure and should not be interpreted to limit the scope thereof. The accompanying drawings are not to be considered as drawn to scale unless explicitly noted.

### DETAILED DESCRIPTION

It will be understood that if an element or layer is referred to as being “on,” “against,” “connected to” or “coupled to” another element or layer, then it can be directly on, against, connected or coupled to the other element or layer, or intervening elements or layers may be present. In contrast, if an element is referred to as being “directly on,” “directly connected to” or “directly coupled to” another element or layer, then there are no intervening elements or layers present. As used herein, the term “connected/coupled” includes both direct connections and connections in which there are one or more intermediate connecting elements. Like numbers refer to like elements throughout. As used herein, the term “and/or” includes any and all combinations of one or more of the associated listed items.

Spatially relative terms, such as “beneath,” “below,” “lower,” “above,” “upper” and the like may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements describes as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors herein interpreted accordingly.

The terminology used herein is for describing particular embodiments and examples and is not intended to be limiting of exemplary embodiments of this disclosure. As used herein, the singular forms “a,” “an,” and “the” are intended to include the plural forms as well, unless the context clearly indicates otherwise. It will be further understood that the terms “includes” and/or “including,” when used in this specification, specify the presence of stated features, integers, steps, operations, elements, and/or components, but do not preclude the presence or addition of one or more other features, integers, steps, operations, elements, components, and/or groups thereof.

Embodiments of the present disclosure are described below in detail with reference to the drawings. In the drawings, the same or corresponding parts are denoted by the same reference numerals, and redundant description thereof are simplified or omitted as appropriate.

Embodiments of the present disclosure are described in detail below with reference to the drawings.

In the present embodiment, a packaging box for packaging a product, which is an image forming apparatus such as a copier, a facsimile machine, or a printer, as a packaging object will be described as an example. However, the packaging object is not limited as long as the packaging box is formed by coupling multiple coupling objects by a coupler.

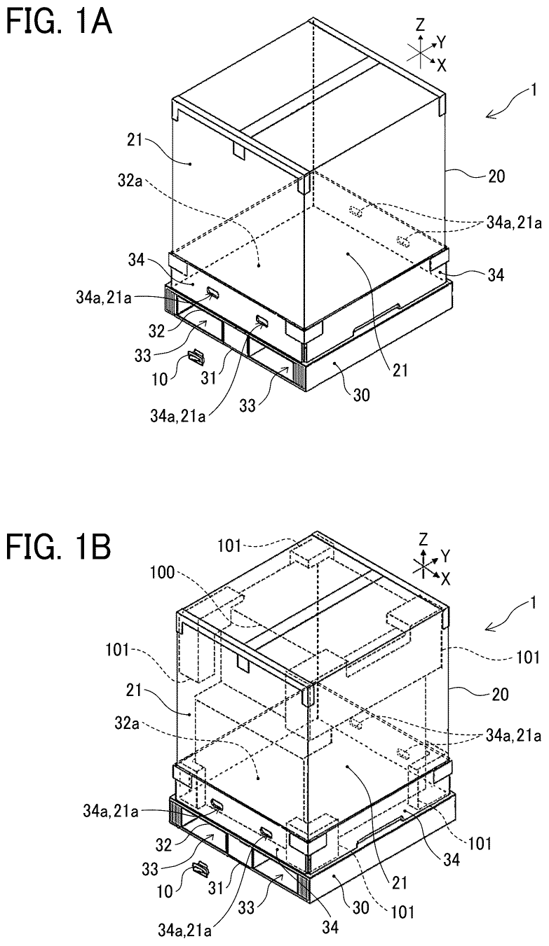

FIG. 1A is a perspective view of a packaging box according to the present embodiment.

FIG. 1B is a perspective view of the packaging box of FIG. 1A, including products drawn in broken lines inside the packaging box according to the present embodiment.

A packaging box 1 according to the present embodiment includes an outer box 20 and a pallet 30. The outer box 20 is to package a product 100 to protect the product 100 by covering the periphery of the product 100 except for the bottom side. The pallet 30 holds the product 100 packaged by the outer box 20 so that the product 100 is conveyed by, for example, a forklift. The packaging box 1 holds the product 100 by placing the bottom side of the product 100 packaged by the outer box 20 on the pallet 30. The outer box 20 and the pallet 30 may be bound and fixed with a binding member such as a band or bands so as not to cause load shifting. The packaging box 1 having this configuration is placed downward on a floor, handled, or conveyed, with the pallet 30 facing downward.

The outer box 20 includes a packaging material such as a corrugated cardboard plate (including a plastic corrugated cardboard), and has a rectangular box shape with the lower side opened. The outer box 20 has an internal volume that can contain the product 100 together with cushioning materials 101 such as styrofoam in order to prevent damage to the product 100.

The pallet 30 is disposed to face the bottom face of the product 100, and includes an installation face member 31 to face the floor on which the product 100 is installed and an upper face member 32 on which the product 100 is placed. The pallet 30 has a given thickness between the installation face member 31 and the upper face member 32 so that the pallet 30 can hold the installation face member 31 and the upper face member 32 to be disposed vertically facing each other.

The pallet 30 has forklift openings 33 between the installation face member 31 and the upper face member 32. The forks of a forklift are inserted into the forklift openings 33 to hold and move the pallet 30.

The pallet 30 includes an upper face member 32 and side walls 34. The upper face member 32 has an upper face 32a and holds the bottom side of the product 100. The side walls 34 are disposed at the ends of the upper face 32a of the upper face member 32 and protrude upward so that the upper face 32a of the upper face member 32 is surrounded by the side walls 34. When the outer box 20 for packaging the product 100 is loaded on the upper face 32a of the upper face member 32, the inner faces of the side walls 34 of the pallet 30 face the outer faces of side walls 21 of the outer box 20 near the bottom face of the outer box 20. In other words, the side walls 34 of the pallet 30 and the side walls 21 of the outer box 20 are disposed to overlap each other. The outer faces of the side walls 34 of the pallet 30 may face the inner faces of the side walls 21 of the outer box 20 near the bottom face of the outer box 20.

As illustrated in FIGS. 1A and 1B, the side walls 34 of the pallet 30 have through holes 34a. Further, as illustrated in FIGS. 1A and 1B, the side walls 21 of the outer box 20 near the bottom face of the outer box 20 (the parts overlapped with the side walls 34 of the pallet 30) have through holes 21a. These through holes 21a and 34a are disposed at positions where the through holes 21a and 34a overlap each other when the outer box 20 is appropriately loaded on the upper face 32a of the upper face member 32 (when the side walls 21 of the outer box 20 and the side walls 34 of the pallet 30 are appropriately overlapped on one after another).

The couplers 10 are inserted into the through holes 21a and 34a thus overlapping each other. By so doing, the side walls 21 of the outer box 20 and the side walls 34 of the pallet 30 are joined (coupled) to each other by the couplers 10.

A description is given below of the couplers 10 according to the present embodiment. The couplers 10 may be referred to as a “coupler 10” in a singular form for convenience.

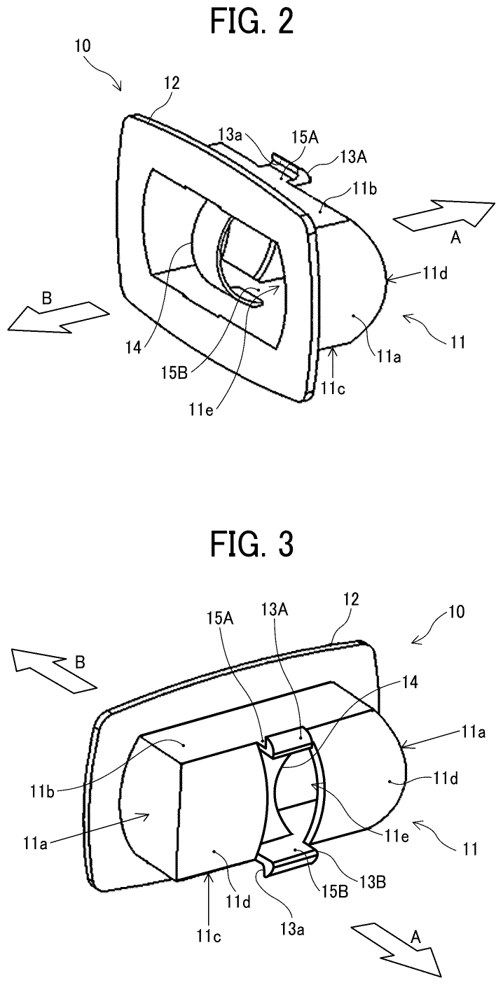

FIG. 2 is a front perspective view of the coupler 10 according to the present embodiment.

FIG. 3 is a perspective view of the coupler 10 according to the present embodiment, viewed from the back side.

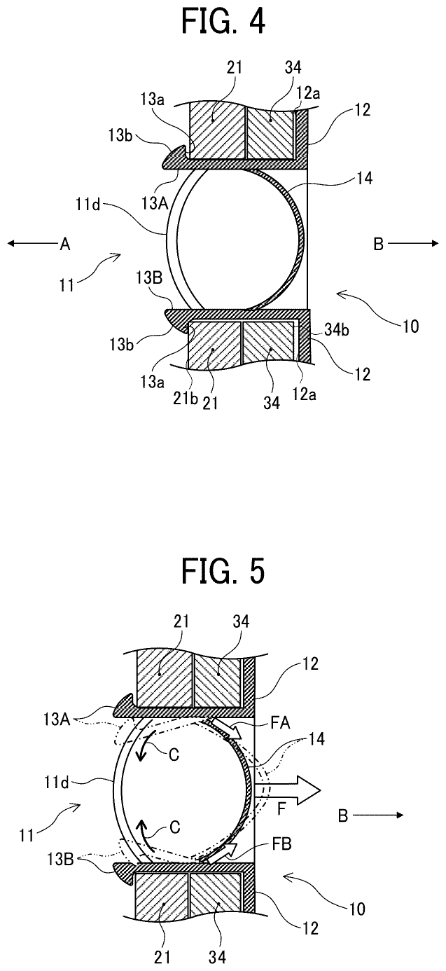

FIG. 4 is a cross-sectional view of the coupler 10 when the side wall 21 of the outer box 20 and the side wall 34 of the pallet 30 are coupled to each other by the coupler 10.

The coupler 10 according to the present embodiment is a molded article made of a resin material such as a hard synthetic resin, but the material and the manufacturing method, for example, are not limited to the material and the manufacturing method employed in the present embodiment. For example, the coupler 10 may be a molded article of a paper material, in other words, a material derived from plant fibers. In particular, the coupler 10 including a paper material can have excellent recyclability and can be environmentally friendly.

The coupler 10 according to the present embodiment is an integrally molded article made of a resinous material and including a base 11 as an insertion portion, a flange 12, hook portions 13A and 13B, and a removal piece 14 as a removal force receiver.

The base 11 is inserted into the through holes 21a and 34a, with the side wall 21 of the outer box 20 and the side wall 34 of the pallet 30 overlapping each other. The base 11 has a hollow shape having an inner space with an opening on the front side. The base 11 includes base side walls 11a on the side faces, a base upper wall 11b on the upper face, a base lower wall 11c on the lower face, and a base rear wall 11d as an end wall on the rear face. A space surrounded by these walls 11a, 11b, 11c and 11d is an inner space of the base 11.

The flange 12 is a planar member that is disposed so as to capture the edge of the front opening on the front side of the base 11 (upstream from the base 11 in the insertion direction A) and extends from the edge of the front opening in a direction substantially parallel to a plane orthogonal to the insertion direction A from the edge of the front opening, so as to be away from the front opening. As illustrated in FIG. 4, when the base 11 is inserted into the through hole 21a of the side wall 21 of the outer box 20 and the through hole 34a of the side wall 34 if the pallet 30, the flange 12 contacts the edge of the through hole 34a of the side wall 34 of the pallet 30, which functions as a coupling object, disposed on the front side (the extreme upstream in the insertion direction A). To be more specific, as illustrated in FIG. 4, the flange 12 has contact a contact face 12a to contact a face 34b of the side wall 34 of the pallet 30 at the extreme upstream position in the insertion direction A when the base 11 is inserted to through holes 21a and 34a.

Of the hook portions 13A and 13B, the upper hook portion 13A is protruded toward the rear side (downstream side in the insertion direction A) from around the lateral center of the base upper wall 11b of the base 11. The lower hook portion 13B is protruded toward the rear side (downstream side in the insertion direction A) from around the lateral center of the base lower wall 11c of the base 11. As illustrated in FIG. 4, when the base 11 is inserted in the through holes 21a and 34a, the side wall 21 of the outer box 20 and the side wall 34 of the pallet 30 are sandwiched between turned-back faces 13a of the hook portions 13A and 13B and the face of the flange 12. To be more specific, as illustrated in FIG. 4, the hook portions 13A and 13B have the turned-back faces 13a each as a contact face to contact a face 21b of the side wall 21 of the outer box 20 at the extreme downstream position in the insertion direction A when the base 11 is inserted to through holes 21a and 34a.

In other words, the hook portions 13A and 13B function as hooks or gripping portions that sandwich the side wall 21 of the outer box 20 and the side wall 34 of the pallet 30 between the flange 12.

In the present embodiment, as illustrated in FIG. 3, the base rear wall 11d of the base 11 has a rear side opening 11e at the position same as the positions in the lateral direction at which the hook portions 13A and 13B are disposed. Since the base 11 that is a resin-molded product is an elastic member, the two hook portions 13A and 13B are supported so as to be displaceable in the vertical direction (direction in which the two hook portions 13A and 13B approach each other). In other words, in the present embodiment, the base upper wall 11b as a side wall at the same position as the lateral position at which the upper hook portion 13A is disposed functions as an elastic support 15A that supports the upper hook portion 13A so as to be displaceable in a direction (vertical direction) orthogonal to the insertion direction A. Further, the base lower wall 11c as a side wall at the same position as the lateral position at which the lower hook portion 13B is disposed functions as an elastic support 15B that supports the lower hook portion 13B so as to be displaceable in a direction (vertical direction) orthogonal to the insertion direction A.

The removal piece 14 functions as a removal force receiver that receives the removal force in a removal direction B opposite to the insertion direction A that is a direction in which the base 11 is removed from the through holes 21a and 34a. In the present embodiment, the operator inserts the finger from the front opening of the base 11 to hook the finger on the removal piece 14, and pulls out the removal piece 14 in the removal direction B with the finger to remove the base 11 from the through holes 21a and 34a. As a result, in the present embodiment, the pullout force acting on the removal piece 14 when the removal piece 14 is pulled out in the removal direction B by the finger of the operator is the removal force.

In the case where the operation of removing the base 11 from the through holes 21a and 34a is automated by a robot arm, the pullout force that acts on the removal piece 14 when the base 11 is pulled out in the removal direction B by the fingers of the robot arm is the removal force.

In the present embodiment, the upper end of the removal piece 14 is coupled to the base upper wall 11b at the position same as the lateral position at which the upper hook portion 13A is disposed, in other words, a portion that functions as the elastic support 15A that supports the upper hook portion 13A to be displaceable in the vertical direction. Further, the lower end of the removal piece 14 is coupled to the base lower wall 11c at the position same as the lateral position at which the lower hook portion 13B is disposed, in other words, a portion that functions as the elastic support 15B that supports the lower hook portion 13B to be displaceable in the vertical direction. In other words, the removal piece 14 is disposed to bridge (couple) between the elastic support 15A of the upper hook portion 13A and the elastic support 15B of the lower hook portion 13B.

FIG. 5 is a diagram illustrating how the coupler 10 moves when the coupler 10 is removed from the side wall 21 of the outer box 20 and the side wall 34 of the pallet 30.

In the present embodiment, when the coupler 10 is removed from the side wall 21 of the outer box 20 and the side wall 34 of the pallet 30, the operator pulls the removal piece 14 in the removal direction B with the finger. As a result, as illustrated in FIG. 5, the center in the vertical direction of the removal piece 14 moves in the removal direction B due to the pullout force (removal force F). Accordingly, forces FA and FB including respective displacement forces toward the center in the vertical direction of the inner space of the base 11 act on the upper end and the lower end of the removal piece 14, respectively.

As indicated by the two-dot chain lines in FIG. 5, the elastic support 15A of the upper hook portion 13A and the elastic support 15B of the lower hook portion 13B are elastically deformed by the forces FA and FB, respectively, so as to be displaced toward the center in the vertical direction of the inner space of the base 11. As a result, the two hook portions 13A and 13B are displaced toward the center in the vertical direction of the inner space of the base 11 (a direction inward of the through holes 21a and 34a), as indicated by arrows C in FIG. 5. Accordingly, the hook portions 13A and 13B that sandwich the side wall 21 of the outer box 20 and the side wall 34 of the pallet 30 between the flange 12 and the hook portions 13A and 13B are retracted in a direction inward of the through holes 21a and 34a.

When the operator pulls out the removal piece 14 in the removal direction B with the finger, the base 11 is removed from the through holes 21a and 34a in the removal direction B, the coupler 10 is removed from the packaging box 1, and the coupling between the outer box 20 and the pallet 30 is released.

As described above, according to the present embodiment, when the coupler 10 is removed from the packaging box 1, a series of operations from a retraction of the hook portions 13A and 13B to a removal of the base 11 is completed by a single operation in which the operator pulls out the removal piece 14 in the removal direction B with the finger. Accordingly, the operation of removing the coupler 10 from the packaging box 1 is simplified, and the performance of the operator can be enhanced.

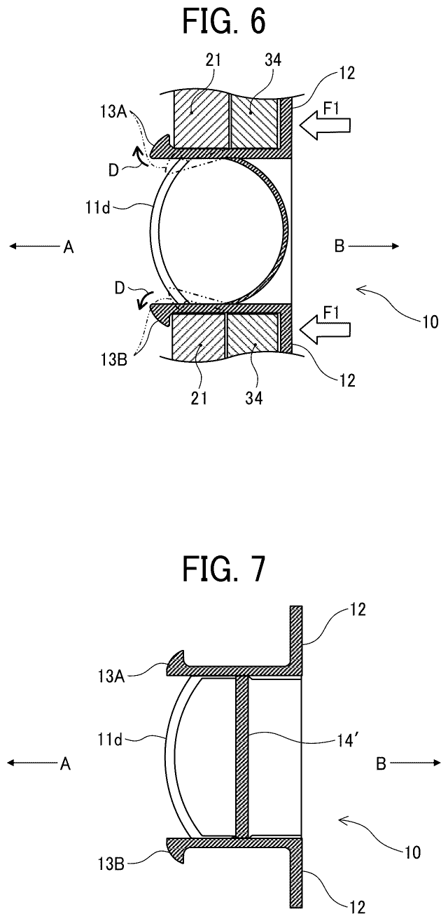

FIG. 6 is a diagram illustrating how the coupler 10 moves when the side wall 21 of the outer box 20 and the side wall 34 of the pallet 30 are coupled to each other with the coupler 10.

When the side wall 21 of the outer box 20 and the side wall 34 of the pallet 30 are coupled to each other with the coupler 10 according to the present embodiment, the operator holds, for example, the edge of the flange 12 with the fingers, and inserts the base 11 into the through holes 21a and 34a with the side wall 21 of the outer box 20 and the side wall 34 of the pallet 30 overlapping each other.

At this time, since the hook portions 13A and 13B are protruded outwardly from the outer peripheral surface of the base 11, respective sloped faces 13b of the hook portions 13A and 13B contact with the edge of the through hole 34a of the side wall 34 of the pallet 30 when the base 11 is inserted into the through holes 21a and 34a. However, as illustrated in FIG. 6, when the operator continues to push the flange 12 in the insertion direction A by the forces F1, the contact portions between the sloped faces 13b of the hook portions 13A and 13B and the edge of the through hole 34a slide along the sloped faces 13b, and the elastic support 15A of the upper hook portion 13A and the elastic support 15B of the lower hook portion 13B are elastically deformed by the force received from the edge of the through hole 34a. Accordingly, as indicated by the two-dot chain lines in FIG. 6, the two hook portions 13A and 13B are displaced to the positions retracted toward the center in the vertical direction of the inner space of the base 11 (direction inward of the through holes 21a and 34a).

Due to such a configuration, the hook portions 13A and 13B are released from being caught by the edge of the through hole 34a of the side wall 34 of the pallet 30. As a result, when the operator continues to push the flange 12 in the insertion direction A, the base 11 is inserted into the through holes 21a and 34a while the hook portions 13A and 13B slide on the inner wall faces of the through holes 21a and 34a.

As the base 11 is inserted into the through holes 21a and 34a until the flange 12 of the coupler 10 comes to contact the edge of the through hole 34a of the side wall 34 of the pallet 30, the hook portions 13A and 13B pass through the through holes 21a and 34a. Accordingly, as indicated by arrows D in FIG. 6, the two hook portions 13A and 13B are displaced outward from the through holes 21a and 34a by the elastic restoring forces of the elastic support 15A of the upper hook portion 13A and the elastic support 15B of the lower hook portion 13B. As a result, the side wall 21 of the outer box 20 and the side wall 34 of the pallet 30 are sandwiched between the turned-back faces 13a of the hook portions 13A and 13B and the flange 12.

Once the side walls 21 and 34 are sandwiched as described above, the coupling of the side wall 21 of the outer box 20 and the side wall 34 of the pallet 30 by the coupler 10 is completed, and the turned-back faces 13a of the hook portions 13A and 13B are caught by the through hole 21a of the side wall 21 of the outer box 20. Accordingly, the coupler 10 is also prevented from being detached from the through holes 21a and 34a.

As described above, according to the present embodiment, when the side wall 21 of the outer box 20 and the side wall 34 of the pallet 30 are coupled by the coupler 10, a series of operations of retracting the hook portions 13A and 13B, inserting the base 11, and sandwiching the side walls 21 and 34 between the hook portions 13A and 13B and the flange 12 are completed by a single operation of pushing the flange 12 of the coupler 10 in the insertion direction A. Accordingly, the operation of coupling with the coupler 10 is simplified, and the performance of the operator can be enhanced.

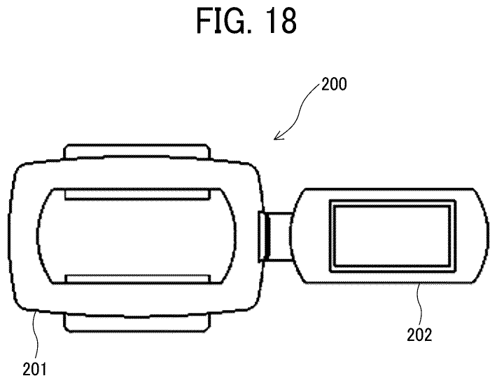

Further, the coupler 10 according to the present embodiment does not require the key member 202 that has been needed separately from the base 201 inserted into the through hole in the typical packaging fastener 200 as illustrated in FIG. 18. Due to such a configuration, the projected area of the coupling component (coupler 10) when the coupler 10 is viewed from the front side can be reduced by the area corresponding to the absence of the key member 202 as compared with the typical packaging fastener 200, and a significant reduction in the amount of material used and a reduction in the size of the manufacturing die can be achieved.

In the present embodiment, the removal piece 14 includes a curved member having a convex shape in the removal direction B, as illustrated in FIG. 4, for example. In this case, when removing the coupler 10, the operator can easily hook the removal piece 14 with the finger, and the performance of the operator can be enhanced. However, the shape of the removal piece 14 is not limited to this shape.

For example, FIG. 7 is a cross-sectional view of the coupler 10 including a removal piece that is a linear member.

As illustrated in FIG. 7, the coupler 10 may have a removal piece 14′ including a linear member extending in a direction orthogonal to the insertion direction A (in other words, the vertical direction in FIG. 7).

Further, FIG. 8 is a cross-sectional view of the coupler including a removal piece that is a curved member protruding outward in a removal direction.

For example, as illustrated in FIG. 8, the coupler 10 may have a removal piece 14″ including a curved member having a convex shape in the removal direction B.

In the present embodiment, the coupling positions (the upper and lower ends of the removal piece 14) at which the removal piece 14 is coupled to the elastic supports 15A and 15B are located near the center of the elastic supports 15A and 15B (the base upper wall 11b and the base lower wall 11c) in the insertion direction as illustrated in FIG. 4. However, the coupling positions are not limited to the above-described coupling positions.

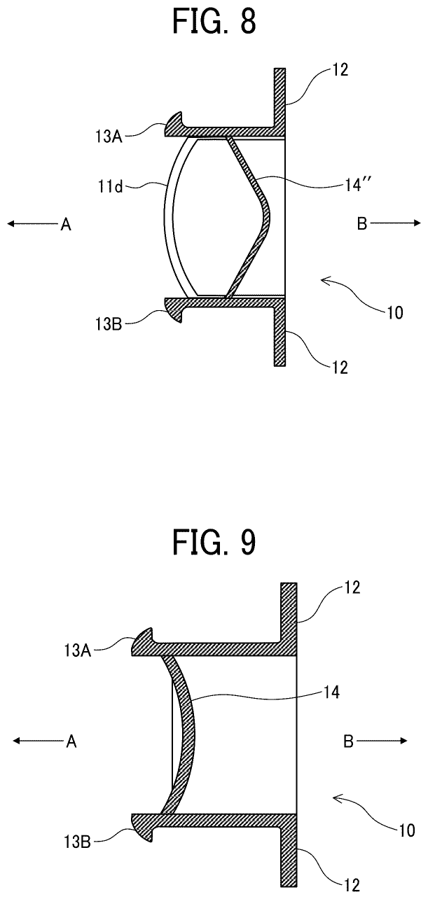

FIG. 9 is a cross-sectional view of the coupler 10 including a removal piece that is coupled to an elastic support at a coupling position disposed downstream from the elastic support in an insertion direction.

In the present embodiment, the coupling positions (the upper and lower ends of the removal piece 14) at which the removal piece 14 is coupled to the elastic supports 15A and 15B may be located near the downstream side of the elastic supports 15A and 15B (the base upper wall 11b and the base lower wall 11c) in the insertion direction A as illustrated in FIG. 9. According to this configuration, when removing the coupler 10, the force (the displacement force indicated by the forces FA and FB in FIG. 5) to displace the two hook portions 13A and 13B to the center (direction inward of the through holes 21a and 34a) in the vertical direction of the inner space of the base 11 can be reduced. As a result, when removing the coupler 10, the pullout force (removal force) F to remove the removal piece 14 can be relatively small, and the performance of the operator can be enhanced.

On the other hand, for example, the coupling positions (the upper and lower ends of the removal piece 14) at which the removal piece 14 is coupled to the elastic supports 15A and 15B may be located near the upstream side of the elastic supports 15A and 15B (the base upper wall 11b and the base lower wall 11c) in the insertion direction A. In this case, the removal piece 14 can be located at a position near the front opening of the base 11 (the opening on the upstream side in the insertion direction A). With this configuration, when removing the coupler 10, the operator can easily hook the removal piece 14 with the finger, and the performance of the operator can be enhanced.

In the present embodiment, the coupling positions (the upper and lower ends of the removal piece 14) at which the removal piece 14 is coupled to the elastic supports 15A and 15B are located at respective overlapped positions overlapped with the hook portions 13A and 13B in the lateral direction. The coupling positions (the upper and lower ends of the removal piece 14) at which the removal piece 14 is coupled to the elastic supports 15A and 15B may be located at respective non-overlapped positions not overlapped with the hook portions 13A and 13B in the lateral direction. However, by locating the coupling positions at the overlapped positions, when removing the coupler 10, the force (the displacement force indicated by the forces FA and FB in FIG. 5) to displace the hook portions 13A and 13B to the center (direction inward of the through holes 21a and 34a) in the vertical direction of the inner space of the base 11 can be reduced, when compared with the case when locating the coupling positions at the non-overlapped positions. As a result, when removing the coupler 10, the pullout force (removal force) F to remove the removal piece 14 can be relatively small, and the performance of the operator can be enhanced.

Further, in the present embodiment, the elastic supports 15A and 15B supporting the hook portions 13A and 13B, respectively, are integrally formed with the other portions of the base upper wall 11b and the base lower wall 11c, which are the side walls of the base 11, but the present disclosure is not limited to this configuration.

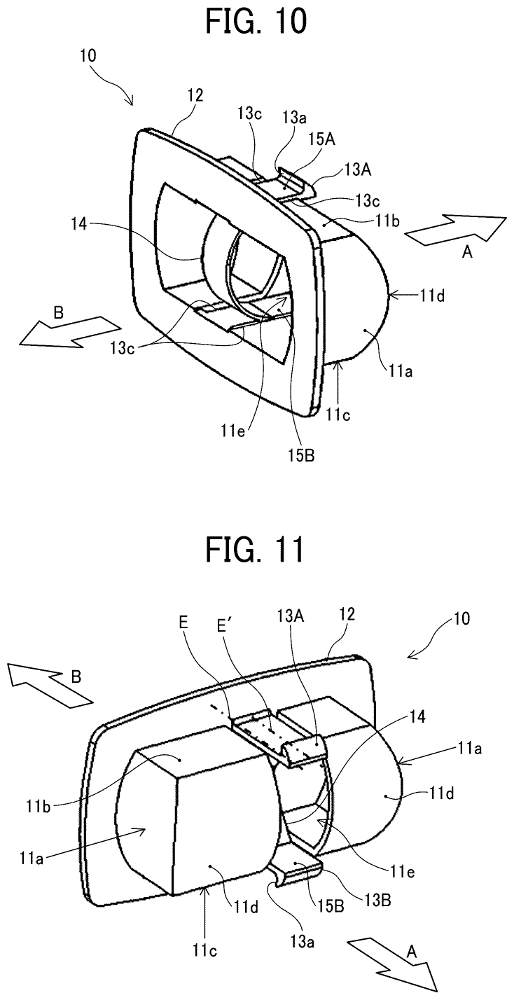

For example, FIG. 10 is a front perspective view of the coupler 10 having a separation structure in which the elastic supports 15A and 15B are displaceably separated from other portions of the base 11 of the coupler 10.

As illustrated in FIG. 10, the elastic supports 15A and 15B may be displaceably separated from the other portions of the base 11.

Specifically, in the configuration illustrated in FIG. 10, the base upper wall 11b and the base lower wall 11c of the base 11 have separation grooves (slots) 13c each extending in the insertion direction A, so that the portions of the base upper wall 11b and the base lower wall 11c included in the elastic supports 15A and 15B, respectively, are displaceably separated from the other portions of the base upper wall 11b and the base lower wall 11c.

As described above, with the configuration in which the elastic supports 15A and 15B are separated from the other portions of the base upper wall 11b and the base lower wall 11c, respectively, when removing the coupler 10, the force (the displacement forces FA and FB in FIG. 5) to displace the hook portions 13A and 13B to the center in the vertical direction of the inner space of the base 11 (direction inward of the through holes 21a and 34a), when compared with the configuration in which the elastic supports 15A and 15B are integrally provided with the other portions of the base upper wall 11b and the base lower wall 11c.

As a result, when removing the coupler 10, the pullout force (removal force) F to remove the removal piece 14 can be relatively small, and the performance of the operator can be enhanced.

Further, FIG. 11 is a rear perspective view of the coupler 10 having the removal piece 14 disposed at a position displaced from the center position in the lateral direction of the inner space of the base 11.

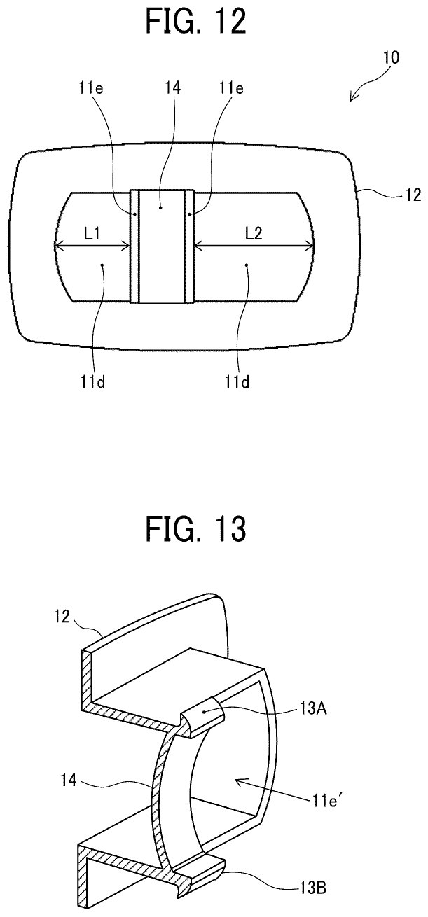

FIG. 12 is a front view of the coupler of FIG. 11.

In the present embodiment, the removal piece 14 is disposed at the center position of the inner space of the base 11 in the lateral direction. However, as illustrated in FIG. 11, the removal piece 14 may be disposed at a position E′ that is displaced from the center position E of the inner space of the base 11 in the lateral direction. In a case where the removal piece 14 is disposed at the center position E of the inner space of the base 11 in the lateral direction, the spaces on both sides of the removal piece 14 in the inner space of the base 11 are equal to each other, and thus it is likely that any space may be too narrow for the operator to insert the fingers when removing the coupler 10.

In contrast, in the configuration illustrated in FIG. 11 in which the removal piece 14 is disposed at a position E′ displaced from the center position E of the inner space of the base 11 in the lateral direction, a lateral length L2 (for example, 1 cm or more) of one side of the side space of the removal piece 14 in the inner space of the base 11 can be made longer than a lateral length L1 on the other side, as illustrated in FIG. 12. In this case, the side space on one side of the removal piece 14 in the inner space of the base 11 can be greater than the side space on the other side of the removal piece 14 in the inner space of the base 11. Due to such a configuration, when removing the coupler 10, the operator can easily hook the removal piece 14 with the fingers, and the performance of the operator can be enhanced.

Further, in the present embodiment, the turned-back faces 13a of the hook portions 13A and 13B and the face of the flange 12 are parallel to each other. Due to such a configuration, the side wall 21 of the outer box 20 and the side wall 34 of the pallet 30, which are parallel to each other, can be sandwiched with no gap. However, in a special case, for example, where the face of the side wall 21 of the outer box 20 and the face of the side wall 34 of the pallet 30 are not parallel to each other, the turned-back faces 13a of the hook portions 13A and 13B and the face of the flange 12 may be not parallel to each other, according to this condition.

The hook portions 13A and 13B according to the present embodiment have respective sloped faces 13b so that, when attaching the coupler 10, the hook portions 13A and 13B can smoothly move inside the through holes 34a from the edges of the through holes 34a of the side walls 34 of the pallet 30. The sloped faces 13b may be flat faces but are preferably curved faces as the present embodiment. According to such a configuration, when attaching the coupler 10, the hook portions 13A and 13B can be moved more smoothly, and the performance of the operator can be enhanced.

FIG. 13 is a partial cross-sectional perspective view of the coupler 10 having no base rear side wall 11d on the rear side of the base 11.

In the present embodiment, the base rear wall 11d as an end wall is disposed on the rear side of the base 11. However, as illustrated in FIG. 13, the present disclosure is applicable to the configuration without any base rear wall 11d, as illustrated in FIG. 13. In other words, as illustrated in FIG. 13, the entire area of the rear side of the base 11 may be open (rear side opening 11e′). However, since the base rear wall 11d is disposed on the rear side of the base 11, the base has a smaller opening area or no opening area on the downstream side of the base 11 in the insertion direction A. Due to such a configuration, when the packaging box 1 is used, the packaging box 1 can be prevented from any foreign matter entering the inside of the packaging box 1 from the outside of the packaging box 1 through the inner space of the base 11 of the coupler 10.

The entire area on the rear side face of the base 11 may be closed by the base rear wall 11d. However, in this case, elastic deformation of the base upper wall 11b and the base lower wall 11c included in the elastic supports 15A and 15B is hindered, and the displacement of the hook portions 13A and 13B is hindered. As a result, the performance of the operator is likely to be deteriorated. Accordingly, as in the present embodiment, as illustrated in FIG. 3, it is preferable that the portion of the rear face side of the base 11 located on the downstream side in the insertion direction A of the elastic supports 15A and 15B is not closed by the base rear wall 11d so that the portion can be left open as a rear side opening 11e, and that the portion other than the rear side opening 11e′ is closed by the base rear wall 11d.

The base rear wall 11d on the rear side of the base 11 preferably has a projection projecting toward the downstream side of the base 11 in the insertion direction A, as illustrated in FIG. 4. According to this configuration, the inner space of the base 11 inside the base rear wall 11d can be extended in the insertion direction A. Accordingly, the space into which the operator can enter the finger is increased on the rear side of the removal piece 14, so that the operator can easily hook space for inserting the fingers of the worker is widened on the back face side of the removal piece 14, so that the worker can easily hook the removal piece 14 with the fingers, and the performance of the operator can be enhanced.

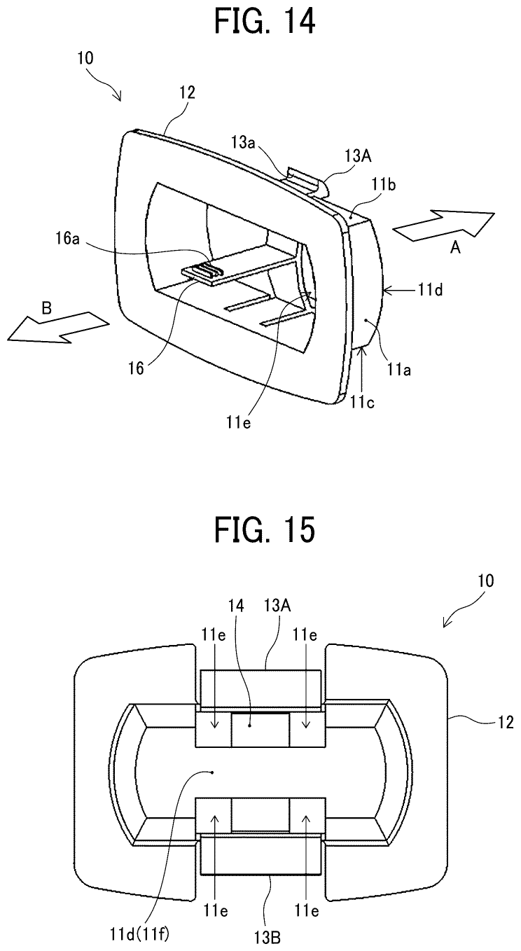

FIG. 14 is a front perspective view of the coupler 10 having a pull piece 16 on the removal piece 14.

As illustrated in FIG. 14, the coupler 10 may include a pull piece 16 as an extension portion on the removal piece 14 and extending in the upstream side in the insertion direction A. According to this configuration, when removing the coupler 10, the operator picks the pull piece 16 by the fingers and pulls the pull piece 16 in the removal direction B. By so doing, as in the above-described embodiment, the coupler 10 can be removed. Accordingly, the operator can be provided with two kinds of methods of removing the coupler 10, in other words, a method of removing the coupler 10 by hooking the finger of the operator on the removal piece 14 and a method of removing the coupler 10 by pulling the pull piece 16. Due to such a configuration, the convenience is enhanced.

Further, as illustrated in FIG. 14, ribs 16a for preventing slippage as a slip-proof may be mounted on the pull piece 16, so that slippage can be reduced when the operator pulls the pull piece 16.

The position of the free end of the pull piece 16 (the position of the end portion on the upstream side in the insertion direction A) may extend from the inner space of the base 11 to the upstream side in the insertion direction A, or may be within the inner space of the base 11.

FIG. 15 is a rear view of the coupler 10 covered by the base rear wall 11d over the entire lateral area on the rear side of the base 11.

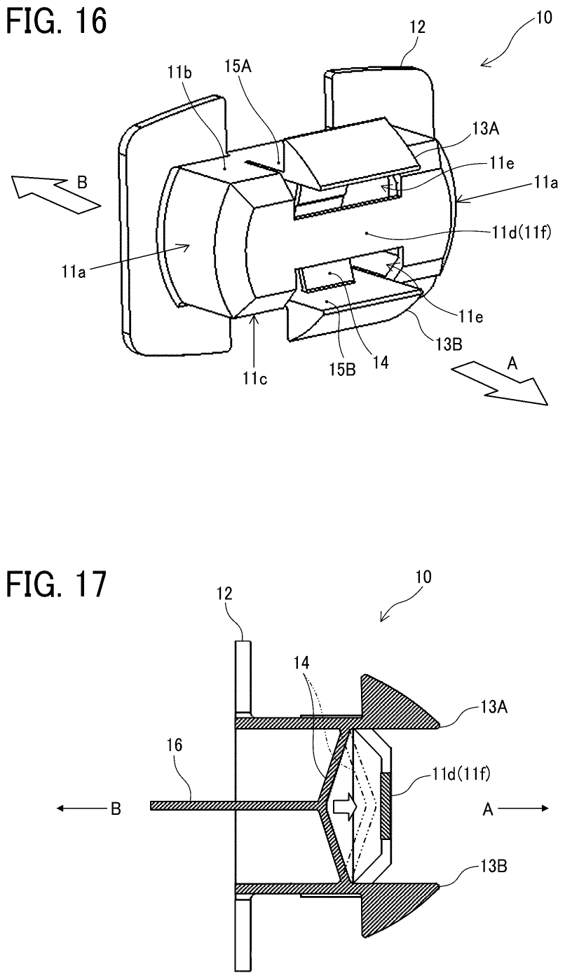

FIG. 16 is a rear perspective view of the coupler 10 of FIG. 15.

FIG. 17 is a cross-sectional view of the coupler 10 of FIG. 15.

As illustrated in FIGS. 15 and 16, the entire lateral area on the rear side of the base 11 may be covered by the base rear wall 11d. To be more specific, when any external force is applied to the removal piece 14 to push the removal piece 14 to the downstream side of the base 11 in the insertion direction A, the removal piece 14 is deformed as indicated by the two-dot chain line in FIG. 17. In order to prevent this inconvenience, the base rear wall 11d functions as a displacement restrainer 11f that contacts the removal piece 14 to restrain the displacement of the removal piece 14. With this configuration, as illustrated in FIGS. 15 and 16, the rear side opening 11e is preferably located at the position same as the lateral positions at which the hook portions 13A and 13B are disposed. Accordingly, as described above, even if the base rear wall 11d is disposed as a displacement restrainer over the entire area in the lateral direction on the rear side of the base 11, the displacements of the hook portions 13A and 13B are less likely to be prevented by the base rear wall 11d.

According to the configuration of FIGS. 15 to 17, as the removal piece 14 is pushed to the downstream side in the insertion direction A so that the removal piece 14 is deformed, the deformed removal piece 14 abuts (contacts) the base rear wall 11d. By so doing, excessive deformation and detachment of the removal piece 14 or excessive deformation and detachment of the hook portions 13A and 13B coupled to the removal piece 14 can be prevented. For example, as in the above-described configuration illustrated in FIG. 14, the configuration illustrated in FIGS. 15 to 17 has the pull piece 16 extending from the inner space of the base 11. Due to such a configuration, when conveying the packaging box 1, the pull piece 16 is pushed to the downstream side in the insertion direction A, and the removal piece 14 may be deformed. Even if the pull piece 16 is pushed to the downstream side in the insertion direction A and the removal piece 14 is deformed when conveying the packaging box 1, the configuration illustrated in FIGS. 15 to 17 can bring the deformed removal piece 14 to contact the base rear wall 11d, and prevent excessive deformation and detachment of the removal piece 14 or excessive deformation and detachment of the hook portions 13A and 13B coupled to the removal piece 14.

In the present embodiment, when the side wall 21 of the outer box 20 and the side wall 34 of the pallet 30 are coupled by the coupler 10, the series of operations can be completed by a single operation of pushing not the flange 12 of the coupler 10 but the removal piece 14 or the pull piece 16 in the insertion direction A by the fingers of the operator. In this operation, according to the configuration of FIGS. 15 to 17, when the removal piece 14 or the pull piece 16 is pushed in the insertion direction A, the removal piece 14 is deformed outward to be a convex shape toward the downstream side in the insertion direction A, as indicated by a two-dot chain line of FIG. 17, and contacts the base rear wall 11d. When the removal piece 14 is deformed to contact the base rear wall 11d, the upper end of the removal piece 14 receives a downward force from the elastic support 15A and the lower end of the removal piece 14 receives an upward force from the elastic support 15B. As a result, even when the removal piece 14 is brought to be deformed in a direction in which the convex portion of the removal piece 14 protruding outward toward the downstream side in the insertion direction A is pushed to the base rear wall 11d, the deformation of the removal piece 14 is prevented by the base rear wall 11d. Accordingly, when the removal piece 14 or the pull piece 16 is pushed in the insertion direction A in the operation of coupling the side wall 21 of the outer box 20 and the side wall 34 of the pallet 30 by the coupler 10, the deformation of the removal piece 14 is maintained when the convex portion of the removal piece 14 is in contact with the base rear wall 11d (indicated by the two-dot chain line in FIG. 17).

According to this configuration, when the side wall 21 of the outer box 20 and the side wall 34 of the pallet 30 are coupled by the coupler 10 and the external force is applied, after the coupling, in a direction in which the hook portions 13A and 13B are retracted, for example, in conveyance of the packaging box 1, the coupler 10 is prevented from being detached from the packaging box 1. Specifically, when such an external force is applied in the direction in which the hook portions 13A and 13B are retracted, the upper end of the removal piece 14 coupled to the upper hook portion 13A and the elastic support 15A receives a downward force and the lower end of the removal piece 14 coupled to the lower hook portion 13B and the elastic support 15B receives an upward force. As a result, the removal piece 14 is brought to be deformed in a direction in which the convex portion of the removal piece 14 protruding outward toward the downstream side in the insertion direction A is pushed to the base rear wall 11d. However, since the deformation of the removal piece 14 is prevented by the base rear wall 11d, even when an external force for retracting the hook portions 13A and 13B is applied, the hook portions 13A and 13B are prevented from retracting, and the coupler 10 is prevented from being detached from the packaging box 1.

The embodiments described above are just examples, and the various aspects of the present disclosure attain respective effects as follows.

### First Aspect

In a first aspect, a coupler (for example, the coupler 10) includes an insertion portion (for example, the base 11), a flange (for example, the flange 12), a hook (for example, the hook portions 13A and 13B), an elastic support (for example, the elastic supports 15A and 15B), and a removal force receiver (for example, the removal piece 14). The insertion portion is inserted to a first opening (for example, the through hole 21a) of a first coupling object (for example, the side wall 21 of the outer box 20) and a second opening (for example, the through hole 34a) of a second coupling object (for example, the side wall 34 of the pallet 30) upstream from the first coupling object, with the first coupling object and the second coupling object overlapping each other. The flange is disposed upstream from the insertion portion in an insertion direction (for example, the insertion direction A). The flange contacts the second opening of the second coupling object at an extreme upstream position in the insertion position when the insertion portion is inserted to the first opening and the second opening. The hook sandwiches the first coupling object and the second coupling object when the insertion portion is inserted to the first opening and the second opening. The elastic support supports the insertion portion to be displaceable in a direction orthogonal to the insertion direction. The removal force receiver receives a removal force (for example, the removal force F) in a removal direction (for example, the removal direction B) opposite to the insertion direction when the insertion portion is removed from the first opening and the second opening. The elastic support is elastically deformed by the removal force received by the removal force receiver, and the hook is displaced to an inward of the first opening and the second opening.

A typical coupler is removed after performing three operations, which are an operation of picking a given position of a key member by the finger of the operator to release the lock claw, an operation of pulling the key member from a base (insertion portion) to retract the hook portion (hook), and an operation of pulling the base from a coupling object through an opening of the coupling object. For this reason, multiple complicated operations are required for the detachment, which degrades the performance of the operator who performs the detachment, for example.

In the coupler according to the first aspect, the insertion portion is inserted into each of the through holes in the respective coupling objects to be coupled with the multiple coupling objects are overlapped with each other, and the multiple coupling objects are sandwiched between the flange formed on the upstream side in the insertion direction of the insertion portion and the hook. By so doing, the multiple coupling objects are coupled. In the coupler according to the first aspect, the hook is supported by the elastic support so as to be displaceable in the direction orthogonal to the insertion direction. The elastic support is coupled to the removal force receiver that receives the removal force (for example, the force the operator pulls in the removal direction by the finger) in the removal direction B when the insertion portion is removed from the openings of the multiple coupling objects. According to the first aspect, when the coupler is removed, the removal force receiver receives the removal force. By so doing, the elastic support coupled to the removal force receiver is elastically deformed and is displaced in a direction inward of the hook that is supported by the elastic support. As a result, the hook that sandwiches the multiple coupling objects between the hook and the flange retreats to the direction inward of the opening. Further, since the removal force the removal force receiver receives is directed in the removal direction, the insertion portion is extracted from each of the openings of the multiple coupling objects by the removal force. As a result, the coupler is removed, and the coupling of the multiple coupling objects is released.

As described above, according to the first aspect, when the coupler is detached, a series of operations from the retraction of the hook to the detachment of the insertion portion is completed by applying the removal force in the removal direction to the removal force receiver. Accordingly, the operation of removing the coupler can be simplified.

Further according to the first aspect, when attaching the coupler, the elastic support is elastically deformed by an operation of pushing the insertion portion into the opening, and then the hook moves the elastic support to the inside of the opening, the multiple coupling objects are sandwiched between the hook and the flange by a restoring force of the elastic support. According to the first aspect, when attaching the coupler, a series of operations until the hook sandwiches the multiple coupling objects between the hook and the flange is completed by a single operation of pushing the insertion portion into the opening. Thus, the operation of attaching the coupler can be simplified. Further, the completion of the series of operations by a single operation of pushing the insertion portion into the opening can simplify the movement of the device in the case of automating the operation of attaching the coupler by a device such as a robot arm, and can be achieved by a relatively inexpensive device.

### Second Aspect

In a second aspect, in the coupler according to the first aspect, the insertion portion has a hollow shape having an inner space, and the removal force receiver is disposed in the inner space of the insertion portion.

According to this configuration, at least a part of the removal force receiver is disposed in the inner space of the insertion portion, and thus the coupler can be reduced in size as compared with a case where the entire removal force receiver is disposed outside the inner space of the insertion portion.

### Third Aspect

In a third aspect, in the coupler according to the second aspect, the removal force receiver is at a position (for example, the position E′) displaced from a center portion (for example, the center position E) of the inner space in a direction orthogonal to the insertion direction and a direction (for example, the lateral direction) orthogonal to a direction in which the hook is displaced to an inside of the first opening and the second opening by elastic deformation of the elastic support by the removal force.

According to this configuration, since a space on one side of the removal force receiver in the inner space of the insertion portion can be widened, the performance of the operator can be enhanced, for example, the operation can easily insert the finger from the wide space side when detaching the coupler.

### Fourth Aspect

In a fourth aspect, in the coupler according to the second aspect or the third aspect, the elastic support includes a side wall (for example, the base upper wall 11b and the base lower wall 11c) of the insertion portion.

According to this configuration, the structure of the coupler can be simplified.

### Fifth Aspect

In a fifth aspect, in the coupler according to the fourth aspect, the elastic support is displaceably separated from another side wall of the insertion portion.

According to this configuration, when detaching the coupler, a force for displacing the hook can be reduced as compared with a case where the elastic support is integrally configured with the other portion of the side wall of the insertion portion. For this reason, the removal force received by the removal force receiver when the coupler is removed is relatively small, and thus the performance of the operator can be enhanced.

### Sixth Aspect

In a sixth aspect, in the coupler according to the fifth aspect, the insertion portion includes an end wall (for example, the base rear wall 11d) to block the downstream area surrounded by the other side wall in the insertion direction and not to block the downstream area of the elastic support in the insertion direction.

According to this configuration, since the opening area on the downstream side of the insertion portion in the insertion direction is reduced or eliminated, the coupler is prevented from a foreign material from passing through the internal space of the base of the coupler when using the coupling objects to be coupled by the coupler.

### Seventh Aspect

In a seventh aspect, in the coupler according to the sixth aspect, an end wall (for example, the base rear wall 11d) has a projection on a downstream side of the insertion portion in the insertion direction.

According to this configuration, the inner space of the insertion portion formed inside the end wall can be expanded in the insertion direction, and the performance of the operator can be enhanced when the operator hooks the removal force receiver with the finger and pulls out the removal force receiver in the removal direction.

### Eighth Aspect

In an eighth aspect, in the coupler according to any one of the first aspect to the seventh aspect, the hook is included in multiple hooks (for example, the hook portions 13A and 13B), the elastic support is included in multiple elastic supports (for example, the elastic supports 15A and 15B), and the removal force receiver is disposed to couple between the multiple elastic supports supporting the multiple hooks.

According to this configuration, when detaching the coupler, the removal force receiver receives the removal force in the removal direction. Due to such a configuration, two or more hooks sandwiching the multiple coupling objects between the hooks and the flange can be retracted to the inward of the opening by a single operation. Accordingly, in the configuration having two or more hooks can simplify the operation when detaching the insertion portion of the coupler.

### Ninth Aspect

In a ninth aspect, in the coupler according to any one of the first aspect to the eighth aspect, the removal force receiver includes a linear member (for example, the removal piece 14′) extending in a direction (for example, the vertical direction) orthogonal to the insertion direction, a first curved member (for example, the removal piece 14) having a convex shape in the removal direction, or a second curved member (for example, the removal piece 14″) having a convex shape in the removal direction.

According to this configuration, the removal force receiver can achieve a simple shape, and the coupler can achieve a simple configuration.

### Tenth Aspect

In a tenth aspect, in the coupler according to any one of the first aspect to the ninth aspect, a coupling position at which the removal force receiver is coupled to the elastic support is located near a downstream side of the elastic support in the insertion direction.

According to this configuration, since the coupling position at which the removal force receiver is coupled to the elastic support is a position close to the hook supported by the elastic support, the force for displacing the hook by the removal force received by the removal force receiver can be reduced. As a result, the removal force received by the removal force receiver is small when detaching the coupler, and thus the performance of the operator can be enhanced.

### Eleventh Aspect

In an eleventh aspect, in the coupler according to any one of the first aspect to the ninth aspect, a coupling position at which the removal force receiver is coupled to the elastic support is located near an upstream side of the elastic support in the insertion direction.

According to this configuration, the operator can be easily accessible to the removal force receiver from the outside, and the performance of the operator can be enhanced when detaching the coupler.

### Twelfth Aspect

In a twelfth aspect, in the coupler according to the eleventh aspect, a coupling position at which the removal force receiver is coupled to the elastic support is located at a position overlapped with the hook in a direction (for example, the lateral direction) orthogonal to the insertion direction of the insertion portion and a direction orthogonal to a direction in which the hook is displaced inward of the opening due to an elastic displacement of the elastic support by the removal force.

According to this configuration, when detaching the coupler, a force for displacing the hook can be reduced as compared with a case where the coupler is disposed at a position (non-overlapping position) which does not overlap with the hook. As a result, the removal force received by the removal force receiver is small when detaching the coupler, and thus the performance of the operator can be enhanced.

### Thirteenth Aspect

In a thirteenth aspect, in the coupler according to any one of the first aspect to the twelfth aspect, the flange has a contact face to contact a face of the second coupling object at the extreme upstream position in the insertion direction when the insertion portion is inserted to the first opening and the second opening.

According to this configuration, since the extreme upstream coupling object in the insertion direction and the flange can be brought into surface contact with each other, the flange that more stably sandwiches the multiple coupling objects between the flange and the hook can be achieved, and thus, a coupler having a high coupling force can be achieved.

### Fourteenth Aspect

In a fourteenth aspect, in the coupler according to any one of the first aspect to the thirteenth aspect, the hook has a contact face (for example, the turned-back faces 13a) to contact a face of the first coupling object at an extreme downstream position in the insertion direction when the insertion portion is inserted to the first opening and the second opening.

According to this configuration, since the extreme downstream coupling object in the insertion direction and the flange can be brought into surface contact with each other, the flange that more stably sandwiches the multiple coupling objects between the flange and the hook can be achieved, and thus, a coupler having a high coupling force can be achieved.

### Fifteenth Aspect

In a fifteenth aspect, in the coupler according to any one of the first aspect to the fourteenth aspect, the hook has a sloped face (for example, the sloped face 13b) facing a downstream side of the hook in the insertion direction, and the sloped face has a flat face or a curved face.

According to this configuration, when attaching the coupler, the elastic support can be elastically deformed by a pushing force for pushing the insertion portion into the opening to smoothly move the hook into the opening, and thus the performance of the operator is enhanced.

### Sixteenth Aspect

In a sixteenth aspect, the coupler according to the first aspect to the fifteenth aspect further includes an extension portion (for example, the pull piece 16) extending from the removal force receiver to an upstream side in the insertion direction.

According to this configuration, since the removal force can be applied to the removal force receiver by pulling the extending portion, a method of removing the coupler by pulling the extending portion can be provided.

### Seventeenth Aspect

In a seventeenth aspect, in the coupler according to the sixteenth aspect, the extension portion includes a slip-proof (for example, the rib 16a) mounted on the extension portion.

According to this configuration, the slip that occurs when the extension portion is pulled can be prevented.

### Eighteenth Aspect

In an eighteenth aspect, in the coupler according to any one of the first aspect to the seventeenth aspect, the coupler is a molded article made of a resin material.

According to this configuration, the coupler can be mass-produced at low cost.

### Nineteenth Aspect

In a nineteenth aspect, in the coupler according to any one of the first aspect to the seventeenth aspect, the coupler is a molded article of a paper material.

According to this configuration, a coupler having an excellent recyclability can be provided.

### Twentieth Aspect

In a twentieth aspect, the coupler according to any one of the first aspect to the eighteenth aspect further includes a displacement restrainer (for example, the displacement restrainer 11f) that restrains the displacement by contacting the removal force receiver when the removal force receiver is displaced in the insertion direction in response to receipt of the external force in the insertion direction.

According to this configuration, even if the removal force receiver receives the external force in the insertion direction and is displaced or deformed, the removal force receiver is brought to contact the displacement restrainer. Due to such a configuration, excessive displacement or deformation of the removal force receiver can be prevented and the durability of the coupler can be enhanced.

Further, during the coupling by the coupler, an external force is applied in a direction in which the hook sandwiching the multiple coupling objects between the hook and the flange retracts inward of the opening, and an inconvenience in which the coupler is unintentionally detached may occur. In the twentieth aspect, when an external force for retracting the hook is applied, the removal force receiver that is coupled to the elastic support supporting the hook may receive a force for deforming the removal force receiver toward the side in contact with the displacement restrainer. With this configuration, even if an external force for retracting the hook is applied during the coupling by the coupler, the displacement restrainer prevents the removal force receiver from being deformed by the external force, and as a result, the hook is prevented from being retracted, and the coupler can be prevented from being detached.

### Twenty-First Aspect

In a twenty-first aspect, a packaging box (for example, the packaging box 1) includes multiple coupling objects (for example, the side wall 21 of the outer box 20 and the side wall 34 of the pallet 30) coupled by the coupler (for example, the coupler 10) according to any one of the first aspect to the twentieth aspect.

### Twenty-Second Aspect

In a twenty-second aspect, a coupler (for example, the coupler 10) includes an insertion portion (for example, the base 11), a flange (for example, the flange 12), a hook (for example, the hook portions 13A and 13B), an elastic support (for example, the elastic supports 15A and 15B), and a removal force receiver (for example, the removal piece 14). The insertion portion is to be inserted, through each of a first opening (for example, the through hole 21a) of a first coupling object (for example, the side wall 21 of the outer box 20) and a second opening (for example, the through hole 34a) of a second coupling object (for example, the side wall 34 of the pallet 30) overlapped with and upstream of the first coupling object, in an insertion direction (for example, the insertion direction A). The flange is coupled to an upstream portion of the insertion portion in the insertion direction, the flange to contact an edge, adjacent to the second opening, of the second coupling object at the most upstream in the insertion position when the insertion portion is inserted to the first opening and the second opening. The hook sandwiches the first coupling object and the second coupling object between the hook and the flange when the insertion portion is inserted into the first opening and the second opening. The elastic support supports the hook displaceable in a direction orthogonal to the insertion direction. The removal force receiver is coupled to the elastic support to receive a removal force (for example, the removal force F) in a removal direction (for example, the removal direction B) opposite to the insertion direction, elastically deform the elastic support by the removal force, and displace the hook inward of the first opening and the second opening, to remove the insertion portion from the first opening and the second opening.

### Twenty-Third Aspect

In a twenty-third aspect, in the coupler according to the twenty-second aspect, the insertion portion has a hollow shape having an inner space, and the removal force receiver is disposed in the inner space of the insertion portion.

### Twenty-Fourth Aspect

In a twenty-fourth aspect, in the coupler according to the twenty-third aspect, the removal force receiver is at a position (for example, the position E′) displaced from a center portion (for example, the center position E) of the inner space in a direction (for example, the lateral direction) orthogonal to the insertion direction and a direction orthogonal to a direction in which the hook is displaced to an inside of the first opening and the second opening by elastic deformation of the elastic support by the removal force.

### Twenty-Fifth Aspect

In a twenty-fifth aspect, in the coupler according to the twenty-third aspect or the twenty-fourth aspect, the insertion portion includes a side wall (for example, the base upper wall 11b and the base lower wall 11c) supporting the elastic support.

### Twenty-Sixth Aspect

In a twenty-sixth aspect, in the coupler according to the twenty-fifth aspect, the insertion portion further includes another side wall,
the elastic support is separated from said another side wall and independently displaceable relative to said another side wall.

### Twenty-Seventh Aspect

In a twenty-seventh aspect, in the coupler according to the twenty-sixth aspect, the insertion portion has an end wall (for example, the base rear wall 11d) having a projection projected downstream in the insertion direction.

### Twenty-Eighth Aspect

In a twenty-eighth aspect, the coupler according to any one of the twenty-second aspect to the twenty-seventh aspect further includes multiple hooks (for example, the hook portions 13A and 13B) including the hook, and multiple elastic supports (for example, the elastic supports 15A and 15B) including the elastic support, the multiple elastic supports supporting the multiple hooks. The removal force receiver couples a portion between the multiple elastic supports.

### Twenty-Ninth Aspect

In a twenty-ninth aspect, in the coupler according to any one of the twenty-second aspect to the twenty-eighth aspect, the removal force receiver includes a linear member (for example, the removal piece 14′) extending in a direction (for example, the vertical direction) orthogonal to the insertion direction, a first curved member (for example, the removal piece 14) having a convex shape in the removal direction, or a second curved member (for example, the removal piece 14″) having a convex shape in the removal direction.

### Thirtieth Aspect

In a thirtieth aspect, in the coupler according to any one of the twenty-second aspect to the twenty-ninth aspect, a coupling position at which the removal force receiver is coupled to the elastic support is located near a downstream side of the elastic support in the insertion direction.

### Thirty-First Aspect

In a thirty-first aspect, in the coupler according to any one of the twenty-second aspect to the twenty-ninth aspect, a coupling position at which the removal force receiver is coupled to the elastic support is located near an upstream side of the elastic support in the insertion direction.

### Thirty-Second Aspect

In a thirty-second aspect, in the coupler according to the thirty-first aspect, a coupling position at which the removal force receiver is coupled to the elastic support is located at a position overlapped with the hook in a direction (for example, the lateral direction) orthogonal to the insertion direction of the insertion portion and a direction orthogonal to a direction in which the hook is displaced inward of the opening due to an elastic displacement of the elastic support by the removal force.

### Thirty-Third Aspect

In a thirty-third aspect, in the coupler according to any one of the twenty-second aspect to the thirty-second aspect, the flange has a contact face to contact a face of the second coupling object at the extreme upstream position in the insertion direction when the insertion portion is inserted to the first opening and the second opening.

### Thirty-Fourth Aspect

In a thirty-fourth aspect, in the coupler according to any one of the twenty-second aspect to the thirty-third aspect, the hook has a contact face (for example, the turned-back faces 13a) to contact a face of the first coupling object at an extreme downstream position in the insertion direction when the insertion portion is inserted to the first opening and the second opening.

### Thirty-Fifth Aspect

In a thirty-fifth aspect, in the coupler according to any one of the twenty-second aspect to the thirty-fourth aspect, the hook has a sloped face (for example, the sloped face 13b) facing a downstream side of the hook in the insertion direction, and the sloped face has a flat face or a curved face.

### Thirty-Sixth Aspect

In a thirty-sixth aspect, the coupler according to the twenty-second aspect to the thirty-fifth aspect further includes an extension portion (for example, the pull piece 16) extending from the removal force receiver to an upstream side in the insertion direction.

### Thirty-Seventh Aspect

In a thirty-seventh aspect, in the coupler according to the thirty-sixth aspect, the extension portion includes a slip-proof (for example, the rib 16a) mounted on the extension portion.

### Thirty-Eighth Aspect

In a thirty-eighth aspect, a packaging box (for example, the packaging box 1) includes multiple coupling objects for example, the side wall 21 of the outer box 20 and the side wall 34 of the pallet 30) coupled by the coupler (for example, the coupler 10) according to any one of the twenty-second aspect to the thirty-seventh aspect.

### Thirty-Ninth Aspect

In a twenty-ninth aspect, a coupler (for example, the coupler 10) includes a flange (for example, the flange 12), an insertion portion (for example, the base 11), multiple hooks (for example, the hook portions 13A and 13B), an elastic support (for example, the elastic supports 15A and 15B), and a removal force receiver (for example, the removal piece 14). The flange has an opening. The insertion portion protrudes from the flange. The multiple hooks each of which is disposed an end of the insertion portion in an insertion direction (for example, the insertion direction A) of the insertion portion. The elastic support supports the multiple hooks to be displaceable. The removal force receiver is coupled to the elastic support inside the insertion portion, and is exposed from the opening of the flange.

### Fortieth Aspect

In a fortieth aspect, in the coupler according to the thirty-ninth aspect, the removal force receiver receives a removal force (for example, the removal force F), the elastic support is elastically deformed by the removal force received by the removal force receiver, and the multiple hooks are displaced to an inward of the insertion portion.

### Forty-First Aspect

In a forty-first aspect, a packaging box (for example, the packaging box 1) includes multiple coupling objects for example, the side wall 21 of the outer box 20 and the side wall 34 of the pallet 30) coupled by the coupler (for example, the coupler 10) according to the thirty-ninth aspect.

According to this configuration, a packaging box having a simplified operation of detaching a coupler can be achieved.

The present disclosure is not limited to specific embodiments described above, and numerous additional modifications and variations are possible in light of the teachings within the technical scope of the appended claims. It is therefore to be understood that, the disclosure of this patent specification may be practiced otherwise by those skilled in the art than as specifically described herein, and such, modifications, alternatives are within the technical scope of the appended claims. Such embodiments and variations thereof are included in the scope and gist of the embodiments of the present disclosure and are included in the embodiments described in claims and the equivalent scope thereof.

The effects described in the embodiments of this disclosure are listed as the examples of preferable effects derived from this disclosure, and therefore are not intended to limit to the embodiments of this disclosure.

The embodiments described above are presented as an example to implement this disclosure. The embodiments described above are not intended to limit the scope of the invention. These novel embodiments can be implemented in various other forms, and various omissions, replacements, or changes can be made without departing from the gist of the invention. These embodiments and their variations are included in the scope and gist of this disclosure and are included in the scope of the invention recited in the claims and its equivalent.

Any one of the above-described operations may be performed in various other ways, for example, in an order different from the one described above.

What is claimed is:

1. A coupler comprising:
an insertion portion to be inserted, through each of a first opening of a first coupling object and a second opening of a second coupling object overlapped with and upstream of the first coupling object, in an insertion direction;
a flange coupled to an upstream portion of the insertion portion in the insertion direction, the flange to contact an edge, adjacent to the second opening, of the second coupling object at the most upstream in the insertion position when the insertion portion is inserted to the first opening and the second opening;
a hook to sandwich the first coupling object and the second coupling object between the hook and the flange when the insertion portion is inserted into the first opening and the second opening;
an elastic support supporting the hook displaceable in a direction orthogonal to the insertion direction; and
a removal force receiver coupled to the elastic support to:
receive a removal force in a removal direction opposite to the insertion direction;
elastically deform the elastic support by the removal force; and
displace the hook inward of the first opening and the second opening, to remove the insertion portion from the first opening and the second opening.

2. The coupler according to claim 1,
wherein the insertion portion has a hollow shape having an inner space, and
the removal force receiver is disposed in the inner space of the insertion portion.

3. The coupler according to claim 2,
wherein the removal force receiver is at a position displaced from a center portion of the inner space in a direction orthogonal to the insertion direction and a direction orthogonal to a direction in which the hook is displaced to an inside of the first opening and the second opening by elastic deformation of the elastic support by the removal force.

4. The coupler according to claim 2,
wherein the insertion portion includes a side wall supporting the elastic support.

5. The coupler according to claim 4,
wherein the insertion portion further includes another side wall,
the elastic support is separated from said another side wall and independently displaceable relative to said another side wall.

6. The coupler according to claim 5,
wherein the insertion portion has an end wall having a projection projected downstream in the insertion direction.

7. The coupler according to claim 1, further comprising:
multiple hooks including the hook; and
multiple elastic supports including the elastic support, the multiple elastic supports supporting the multiple hooks,
wherein the removal force receiver couples a portion between the multiple elastic supports.

8. The coupler according to claim 1,
wherein the removal force receiver includes a linear member extending in a direction orthogonal to the insertion direction, a first curved member having a convex shape in the removal direction, or a second curved member having a convex shape in the removal direction.

9. The coupler according to claim 1,
wherein a coupling position at which the removal force receiver is coupled to the elastic support is located near a downstream side of the elastic support in the insertion direction.

10. The coupler according to claim 1,
wherein a coupling position at which the removal force receiver is coupled to the elastic support is located near an upstream side of the elastic support in the insertion direction.

11. The coupler according to claim 1,
wherein a coupling position at which the removal force receiver is coupled to the elastic support is located at a position overlapped with the hook in a direction orthogonal to the insertion direction of the insertion portion and a direction orthogonal to a direction in which the hook is displaced inward of the opening due to an elastic displacement of the elastic support by the removal force.

12. The coupler according to claim 1,
wherein the flange has a contact face to contact a face of the second coupling object at the extreme upstream position in the insertion direction when the insertion portion is inserted to the first opening and the second opening.

13. The coupler according to claim 1,
wherein the hook has a contact face to contact a face of the first coupling object at an extreme downstream position in the insertion direction when the insertion portion is inserted to the first opening and the second opening.

14. The coupler according to claim 1,
wherein the hook has a sloped face facing a downstream side of the hook in the insertion direction, and
the sloped face has a flat face or a curved face.

15. The coupler according to claim 1, further comprising an extension portion extending from the removal force receiver to an upstream side in the insertion direction.

16. The coupler according to claim 15,
wherein the extension portion includes a slip-proof mounted on the extension portion.

17. A packaging box comprising multiple coupling objects coupled by the coupler according to claim 1.

18. A coupler comprising:
a flange having an opening;
an insertion portion protruding from the flange;
multiple hooks each disposed at an end of the insertion portion in an insertion direction of the insertion portion;
an elastic support to support the multiple hooks to be displaceable; and
a removal force receiver coupled to the elastic support inside the insertion portion, the removal force receiver being exposed from the opening of the flange.

19. The coupler according to claim 18,
wherein the removal force receiver receives a removal force,
the elastic support is elastically deformed by the removal force received by the removal force receiver, and
the multiple hooks are displaced to an inward of the insertion portion.

20. A packaging box comprising multiple coupling objects coupled by the coupler according to claim 18.
